(19) United States
(12) Patent Application Publication
(10) Pub. No.: US 2025/0029475 A1
(43) Pub. Date: Jan. 23, 2025

(54) MONITORING SYSTEM, POSITIONING APPARATUS, POSITIONING METHOD, MONITORING APPARATUS, MONITORING METHOD, AND COMPUTER READABLE RECORDING MEDIUM

(71) Applicant: NEC Corporation, Minato-ku, Tokyo (JP)

(72) Inventors: Shizuo SAKAMOTO, Tokyo (JP); Noriyuki YAMADA, Tokyo (JP); Masahiro HONDA, Tokyo (JP); Megumi FUKUDA, Tokyo (JP)

(73) Assignee: NEC Corporation, Minato-ku, Tokyo (JP)

(21) Appl. No.: 18/714,637

(22) PCT Filed: Dec. 1, 2022
(86) PCT No.: PCT/JP2022/044376

§ 371 Date: May 30, 2024

(30) Foreign Application Priority Data
Dec. 9, 2021 (JP) 2021-200004

(51) Int. Cl. G08B 25/00

(52) U.S. Cl. CPC G08B 25/009

(57) ABSTRACT

A monitoring system, wherein a positioning apparatus, if the position of a target person being monitored is included in an intrusion prohibited zone, generates intrusion prohibited-zone information including position information; if the position of the target person is included in a buffer zone that has been set in the vicinity of the intrusion prohibited zone, generates buffer-zone information; and the monitoring apparatus, upon receiving the intrusion prohibited-zone information, generates, for an output apparatus, output information indicating that the target person has intruded into the intrusion prohibited zone, and, upon receiving the buffer-zone information, generates, for the output apparatus, output information indicating that the target person has intruded into the buffer zone.

### TECHNICAL FIELD

The technical field relates to a monitoring system, a positioning apparatus, a positioning method, a monitoring apparatus, a monitoring method, and a computer readable recording medium for monitoring a target person being monitored.

### BACKGROUND ART

Recent years have seen the occurrence of incidents in which a target person being monitored absconds. A target person being monitored, for example, is a defendant out on bail, a convict on parole, or the like. A defendant out on bail is a suspect of a crime who has been released from custody (physical confinement) following prosecution. A convict on parole is an inmate confined to a penal institution for the execution of custodial sentence (imprisonment with labor, imprisonment without labor, and penal detection) who has been provisionally released before expiration of the sentence term, out of the inmates of the penal institution.

The absconding of a target person being monitored may lead to a new crime. Thus, as a measure for preventing absconding, it is conceivable for judges to make strict decisions regarding bail requirements and requirements for suspending the execution of detention. Furthermore, recent years have seen a trend of bail being granted and execution of detention being suspended from a human-rights perspective.

In view of such circumstances, it is conceivable to have a target person being monitored wear a GPS-based positioning apparatus to monitor the movement thereof. However, there is an opposing view that monitoring with such an apparatus would be a violation of privacy since the movement of the target person being monitored would be monitored at all times. On the other hand, there is an opinion that public safety can be protected by using GPS-based positioning apparatuses.

Thus, there is a demand for a novel monitoring system for monitoring a target person being monitored.

As a related technique, Patent Document 1 discloses a technique in which area information and position information of a target person are used to detect whether or not the target person is present in a notification area including a monitoring-target area, attribute information and state information of the target person are used to estimate the influence that the monitoring-target area in the notification area has on the state of the target person, and the target person is notified of information including content that is in accordance with the result of the estimation.

As a related technique, Patent Document 2 discloses a mobile communication terminal device that allows a person being monitored to be monitored while flexibly adapting to the movement of the person being monitored and monitoring areas that are scattered about and change over time. When monitoring areas have been set, the mobile communication terminal device for a person being monitored disclosed in Patent Document 2 compares the current position detected by a GPS sensor and the set monitoring areas, and transmits an emergency transmission mail to a portable telephone of a monitoring person if an abnormality is determined.

### LIST OF RELATED ART DOCUMENTS

### Patent Document

Patent Document 1: International Publication No. 2014/129159
Patent Document 2: Japanese Patent Laid-Open Publication No. 2004-355243

### SUMMARY OF INVENTION

### Problems to be Solved by the Invention

However, neither one of the techniques disclosed in Patent Documents 1 and 2 is for monitoring a target person being monitored.

As one aspect, an example object is to provide a monitoring system, a positioning apparatus, a positioning method, a monitoring apparatus, a monitoring method, and a computer readable recording medium for performing movement restriction of a target person being monitored.

### Means for Solving the Problems

In order to achieve the example object described above, a monitoring system according to an example aspect includes:
a positioning apparatus:
   if the position of a target person being monitored is included in an intrusion prohibited zone that has been set based on the reason why the target person is being monitored, generates intrusion prohibited-zone information including position information indicating the position of the target person and intrusion prohibited information indicating that the target person has intruded into the intrusion prohibited zone;
   if the position of the target person is included in a buffer zone that has been set in the vicinity of the intrusion prohibited zone, generates buffer-zone information including the position information and buffer information indicating that the target person has intruded into the buffer zone; and
   transmits the intrusion prohibited-zone information to a monitoring apparatus if the position of the target person is included in the intrusion prohibited zone, and transmits the buffer-zone information to the monitoring apparatus if the position of the target person is included in the buffer zone, and
the monitoring apparatus
   upon receiving the intrusion prohibited-zone information, generates, for an output apparatus, output information indicating that the target person has intruded into the intrusion prohibited zone, and, upon receiving the buffer-zone information, generates, for the output apparatus, output information indicating that the target person has intruded into the buffer zone.

Also, in order to achieve the example object described above, a positioning apparatus according to an example aspect includes:
determination unit that determines whether or not the position of a target person being monitored is included in an intrusion prohibited zone that has been set based on the reason why the target person is being monitored; if the position of the target person is included in the intrusion prohibited zone, generates intrusion prohibited-zone information including position information indicating the position of the target person and intrusion prohibited information indicating that the target person has intruded into the intrusion prohibited zone; and, if the position of the target person is included in a buffer zone that has been set in the vicinity of the intrusion prohibited zone, generates buffer-zone information including the position information and buffer information indicating that the target person has intruded into the buffer zone; and
notification unit that notifies the target person that the target person has intruded into the intrusion prohibited zone or the buffer zone.

Also, in order to achieve the example object described above, a positioning method that is performed by a computer according to an example aspect includes:
determining whether or not the position of a target person being monitored is included in an intrusion prohibited zone that has been set based on the reason why the target person is being monitored; if the position of the target person is included in the intrusion prohibited zone, generating intrusion prohibited-zone information including position information indicating the position of the target person and intrusion prohibited information indicating that the target person has intruded into the intrusion prohibited zone; and, if the position of the target person is included in a buffer zone that has been set in the vicinity of the intrusion prohibited zone, generating buffer-zone information including the position information and buffer information indicating that the target person has intruded into the buffer zone; and
notifying the target person that the target person has intruded into the intrusion prohibited zone or the buffer zone.

Also, in order to achieve the example object described above, a computer-readable recording medium according to an example aspect includes a program recorded on the computer-readable recording medium, the program including instructions that cause the computer to carry out:
determining whether or not the position of a target person being monitored is included in an intrusion prohibited zone that has been set based on the reason why the target person is being monitored; if the position of the target person is included in the intrusion prohibited zone, generating intrusion prohibited-zone information including position information indicating the position of the target person and intrusion prohibited information indicating that the target person has intruded into the intrusion prohibited zone; and, if the position of the target person is included in a buffer zone that has been set in the vicinity of the intrusion prohibited zone, generating buffer-zone information including the position information and buffer information indicating that the target person has intruded into the buffer zone; and
notifying the target person that the target person has intruded into the intrusion prohibited zone or the buffer zone.

Also, in order to achieve the example object described above, a monitoring apparatus according to an example aspect includes:
intrusion prohibited-zone-setting-information generating unit that, based on the reason why a target person is being monitored, generates intrusion prohibited-zone setting information for setting an intrusion prohibited zone to a positioning apparatus;
buffer-zone-setting-information generating unit that generates buffer-zone setting information for setting a buffer zone in the vicinity of the intrusion prohibited zone; and
communicating unit that transmitters the intrusion prohibited-zone setting information and the buffer-zone setting information to the positioning apparatus.

Also, in order to achieve the example object described above, a monitoring method that is performed by a computer according to an example aspect includes:
based on the reason why a target person is being monitored, generating intrusion prohibited-zone setting information for setting an intrusion prohibited zone to a positioning apparatus;
generating buffer-zone setting information for setting a buffer zone in the vicinity of the intrusion prohibited zone; and
transmitting the intrusion prohibited-zone setting information and the buffer-zone setting information to the positioning apparatus.

Furthermore, in order to achieve the example object described above, a computer-readable recording medium according to an example aspect includes a program recorded on the computer-readable recording medium, the program including instructions that cause the computer to carry out:
based on the reason why a target person is being monitored, generating intrusion prohibited-zone setting information for setting an intrusion prohibited zone to a positioning apparatus;
generating buffer-zone setting information for setting a buffer zone in the vicinity of the intrusion prohibited zone; and
transmitting the intrusion prohibited-zone setting information and the buffer-zone setting information to the positioning apparatus.

### Advantageous Effects of the Invention

As one aspect, movement restriction of a target person being monitored is performed.

### BRIEF DESCRIPTION OF THE DRAWINGS

FIG. 1 is a diagram for describing an example of a configuration of a monitoring system.

FIG. 2 is a diagram for describing continuity and comprehensiveness.

FIG. 3 is a diagram for describing the degradation of date/time information.

FIG. 4 is a diagram for describing the degradation of position information and date/time information.

FIG. 5 is a diagram for describing the degradation of position information.

FIG. 6 is a diagram for describing intrusion prohibited zones and buffer zones.

FIG. 7 is a diagram for describing an example of state display information.

FIG. 8 is a diagram for describing an example of intrusion-route display information.

FIG. 9 is a diagram for describing an example of intruder-details display information.

FIG. 10 is a diagram for describing an example of operations of the positioning apparatus.

FIG. 11 is a diagram for describing an example of operations of the monitoring apparatus.

FIG. 12 is a diagram for describing an example of operations of the monitoring apparatus.

FIG. 13 is a diagram for describing an example of a computer that realizes the positioning apparatus and the monitoring apparatus.

### EXAMPLE EMBODIMENT

### Example Embodiment

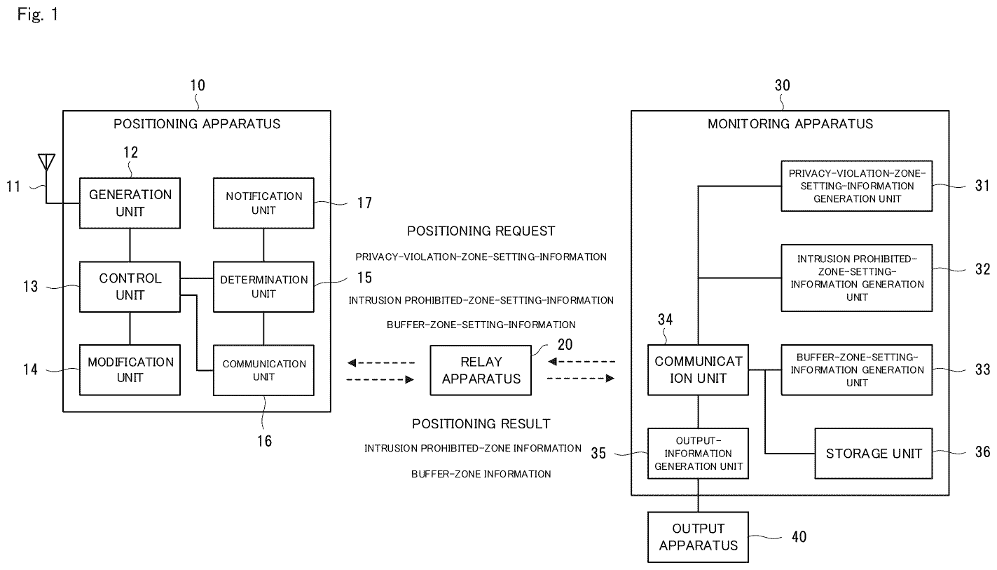

A configuration of a monitoring system in an example embodiment will be described with reference to FIG. 1. FIG. 1 is a diagram for describing an example of a configuration of a monitoring system.

### [System Configuration]

As illustrated in FIG. 1, the system includes a positioning apparatus 10, a relay apparatus 20, and a monitoring apparatus 30.

The positioning apparatus will be described. The positioning apparatus 10 is an apparatus that prevents a target person being monitored from absconding and also protects the privacy of the target person being monitored. The target person being monitored, for example, is a defendant out on bail, a convict on parole, or the like.

For example, the positioning apparatus 10 is an apparatus including a central processing unit (CPU), a programmable device such as a field-programmable gate array (FPGA), or a circuit, a computer, or the like in which at least one of a CPU and a programmable device is installed. For example, the positioning apparatus 10 is a dedicated apparatus or wrist-watch-type device worn by the target person being monitored, a smartphone, or the like.

Here, for example, the dedicated apparatus or wrist-watch-type device is provided with a function for reporting to the monitoring apparatus 30 when the target person takes off the dedicated apparatus. Alternatively, the dedicated apparatus, wrist-watch-type device, or smartphone is provided with a function for reporting to the monitoring apparatus 30 if authentication is not performed at predetermined time intervals.

The positioning apparatus 10 includes an antenna unit 11, a generation unit 12, a control unit 13, a modification unit 14, a determination unit 15, a communication unit 16, and a notification unit 17.

For example, the antenna unit 11 receives satellite signals (digital signals) transmitted from a plurality of artificial satellites used in a global navigation satellite system or the like.

The generation unit 12 measures the position of the target person being monitored based on the satellite signals received from the artificial satellites, and generates position information (first position information) indicating the position of the target person and date/time information (first date/time information) indicating the date and time when positioning was performed.

Specifically, by performing positioning processing using satellite signals, the generation unit 12 generates position information (first position information) indicating the position (latitude and longitude) of the target person and date/time information (first date/time information) indicating the date and time when positioning was performed. As the positioning processing, processing in which code positioning method, carrier positioning method, or the like is used is conceivable. However, the positioning processing is not limited to the above-described processing.

The control unit 13 outputs an instruction for causing the generation unit 12 to start positioning upon receiving a positioning request from the communication unit 16. Then, the control unit 13 acquires position information (first position information) and date/time information (first date/time information), which are a positioning result generated by the generation unit 12.

Next, the control unit 13 outputs the positioning result (first position information and/or first date/time information) to the modification unit 14. Then, upon acquiring the positioning result on which degradation processing has been performed by the modification unit 14 (second position information and/or second date/time information), the control unit 13 outputs the positioning result on which the degradation processing has been performed to the communication unit 16.

Note that, while the control unit 13 is provided inside the positioning apparatus 10 in the example in FIG. 1, the function of the control unit 13 may be provided to a server computer that is provided outside the positioning apparatus 10.

The modification unit 14 modifies a positioning result (first position information and/or first date/time information) in accordance with a privacy violation zone indicating a zone that would result in the privacy of the target person being violated, and generates a modified positioning result (second position information and/or second date/time information).

For example, a privacy violation zone is a zone in which the target person's residence, a medical facility (for example, a hospital or pharmacy) that the target person is visiting, or the like is present. Also, a privacy violation zone is a zone in which, if the target person is in the position of the zone, the target person would suffer from disadvantages such as irrational discrimination or prejudice directed toward the target person him or herself such as those based on race, belief, social status, medical history, criminal record, or the fact of being victim to a crime, or the like.

Note that one or more privacy violation zones are stored in advance in an unillustrated storage unit of the positioning apparatus 10. Alternatively, for each individual target person, one or more privacy violation zones may be set by a person concerned.

The modification of position information and/or date/time information (positioning result) is processing for making it difficult to specify that the target person was present in a position resulting in the privacy of the target person being violated. For example, as the modification, (1) processing of deleting a positioning result in a privacy violation zone, (2) processing of disturbing a positioning result in a privacy violation zone by adding a random number to the positioning result, or the like is conceivable. Furthermore, as the modification, (3) degrading a positioning result in a privacy violation zone is also conceivable.

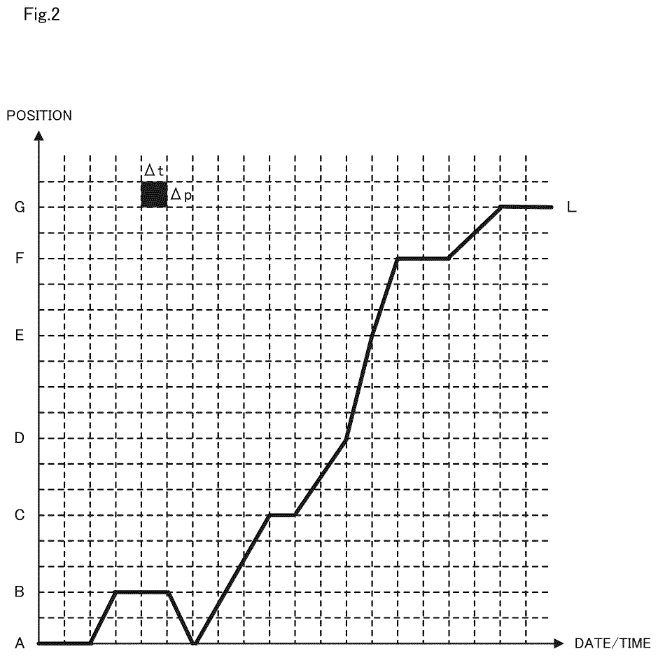

(3) The degradation of a positioning result will be described. FIG. 2 is a diagram for describing continuity and comprehensiveness. In the graph in FIG. 2, the vertical axis indicates positions (A (point of departure) to G (point of arrival)) specified by latitude and longitude, and the horizontal axis indicates the date and time (year, month, date, time, or the like). Furthermore, Δp and Δt shown in FIG. 2 respectively indicate a distance interval and a time interval set for the acquisition of positioning results.

Here, continuity can be regarded as a characteristic indicating the time-series continuation of positioning results, and it can thus be said that the longer the period of time during which positioning results are acquired, the higher the continuity. Comprehensiveness can be regarded as a characteristic indicating that positioning results are acquired exhaustively within a given range, and it can thus be said that the smaller the distance interval Δp and the time interval Δt, the higher the comprehensiveness.

Thus, continuity can be reduced by (3-1) limiting the period during which positioning results are acquired or (3-2) increasing the time interval Δt.

Furthermore, comprehensiveness can be reduced by (3-3) increasing the time interval Δt and the distance interval Δp. Alternatively, comprehensiveness can be reduced by (3-4) only increasing the distance interval Δp.

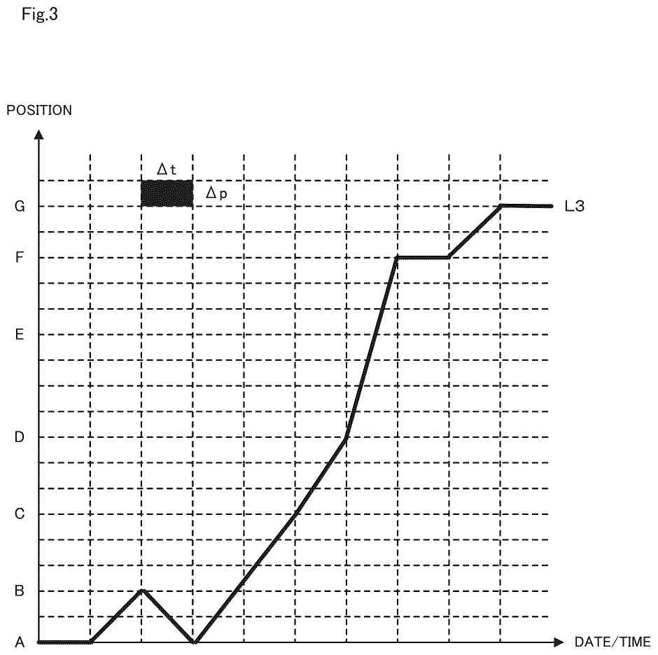

In actual processing, it suffices that the period during which positioning results are acquired be limited to realize (3-1). It suffices that the time interval Δt be increased as illustrated in FIG. 3 to realize (3-2). FIG. 3 is a diagram for describing the degradation of date/time information.

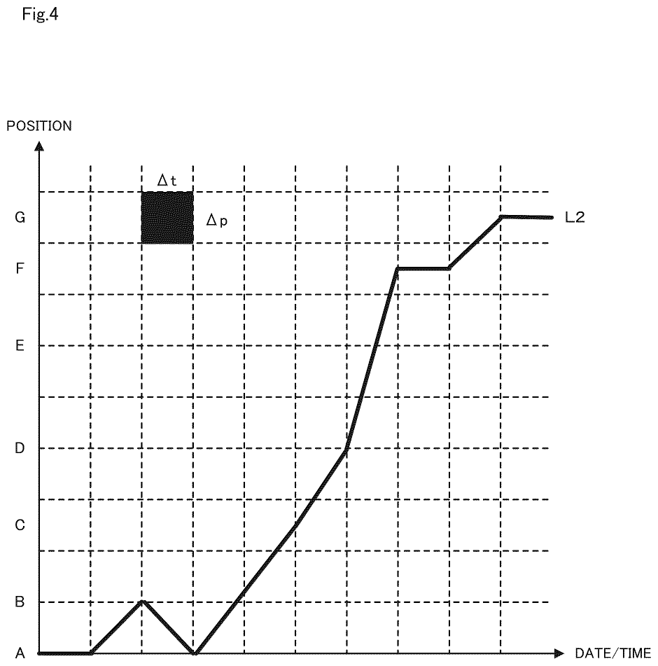

It suffices that the distance interval Δp and the time interval Δt be increased as illustrated in FIG. 4 to realize (3-3). FIG. 4 is a diagram for describing the degradation of position information and date/time information.

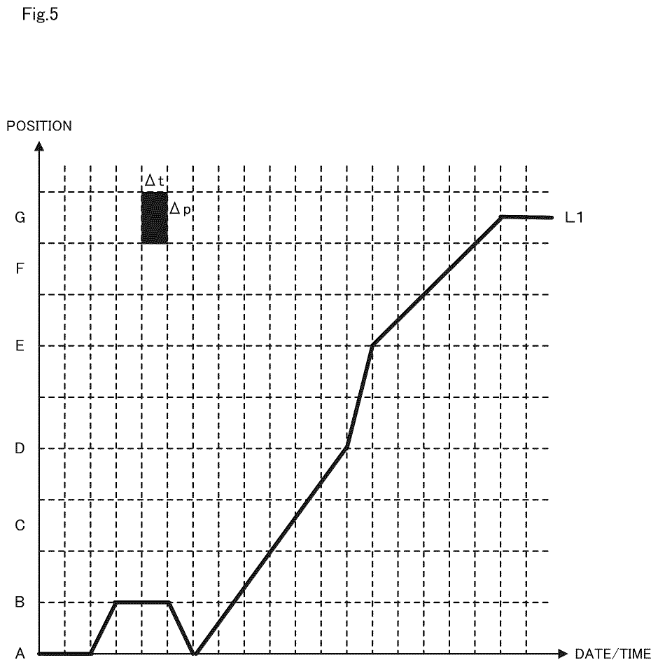

It suffices that the distance interval Δp be increased as illustrated in FIG. 5 to realize (3-4). FIG. 5 is a diagram for describing the degradation of position information. Note that an increase in the distance interval Δp is equivalent to an increase in area size.

In other words, the smaller the area indicated by Δp×Δt, the higher the continuity and comprehensiveness, and the greater the amount of information that can be obtained during a positioning period. Conversely, the larger the area, the lower the continuity and comprehensiveness, and the smaller the amount of information that can be obtained as a whole.

Accordingly, as illustrated in FIGS. 3 to 5, the area Δp×Δt increases in each of the above-described cases, and the amount of information indicated by lines L1, L2, and L3 indicating movement history in FIGS. 3 to 5 is less than that indicated by line L indicating movement history in FIG. 3.

Specifically, if only the distance interval Δp is increased as in FIG. 3, the whereabouts of the target person can be represented only by latitude and longitude, and thus the position information that can be acquired is coarser compared to that in the case of FIG. 2. Furthermore, as illustrated in FIG. 4, if the time interval Δt is increased in a state in which the distance interval Δp is kept the same as that in FIG. 2, the granularity of date/time information becomes coarser although the whereabouts of the target person can be acquired accurately.

Thus, the privacy of the target person being monitored can be protected by degrading positioning information as described above.

Specifically, if the position indicated by position information is included in a privacy violation zone, the modification unit 14 modifies date/time information (time interval Δt) based on date/time-information modification processing associated with the privacy violation zone so that the time during which the target person stayed in the privacy violation zone cannot be specified.

That is, in a privacy violation zone, the modification unit 14 increases the time interval Δt based on the date/time-information modification processing. Note that the method of modification in the date/time-information modification processing may be changed depending on the type of privacy violation zone.

The date/time-information modification processing is processing for, if the target person passes through a target object (building or the like) that would result in privacy being violated, making it difficult to identify the date and time when the target person passed through the target object (point). For example, the date/time-information modification processing is processing of modifying the time interval Δt to a magnitude with which a preset number of people or vehicles would be able to pass though the target object that is estimated to cause privacy violation.

Alternatively, for example, the date/time-information modification processing is processing of modifying the time interval Δt to a magnitude with which a preset number of people or vehicles would be able to stay in the target object that is estimated to cause privacy violation.

Furthermore, if the position indicated by position information is included in a privacy violation zone, the modification unit 14 may acquire date/time information after a preset amount of time has elapsed from the previous instance of positioning.

Next, specifically, if the position indicated by position information is included in a privacy violation zone, the modification unit 14 modifies the position information (distance interval Δp) based on position-information modification processing associated with the privacy violation zone so that the position of the target person cannot be specified.

That is, in a privacy violation zone, the modification unit 14 increases the distance interval Δp based on the position-information modification processing. Note that the method of modification in the position-information modification processing may be changed depending on the type of privacy violation zone.

The position-information modification processing is processing for concealing, among a plurality of other target objects, a target object that is estimated to cause privacy violation, and thereby reducing the possibility of the target object being identified. However, necessary information still needs to be capable of being acquired.

In actual processing, in a case in which a target object that is estimated to cause privacy violation is a building, processing is performed so that the target person and/or the building cannot be specified. That is, the distance interval Δp is set to a magnitude with which a plurality of buildings would be included in the vicinity of the building.

Alternatively, the distance interval Δp may be set to a magnitude with which a plurality of people or vehicles would be concurrently present in the vicinity of the target person.

Note that it is desirable that the magnitudes of the distance interval Δp and the time interval Δt be set based on experience, circumstances, etc., acquired through past cases.

The determination unit 15 determines whether or not the position of the target person is included in an intrusion prohibited zone that has been set based on the reason why the target person is being monitored, and, if the position of the target person is included in an intrusion prohibited zone, the determination unit 15 generates intrusion prohibited-zone information including position information (first position information) indicating the position of the target person and intrusion prohibition information indicating that the target person has intruded into the intrusion prohibited zone.

As the reason why the target person is being monitored, the reason why the target person has been released on bail or on parole is conceivable, for example. The intrusion prohibited-zone information includes position information indicating the current position of the target person, and intrusion prohibition information (for example, a flag or the like) indicating whether or not the target person has intruded into an intrusion prohibited zone.

If the target person is out on bail or on parole, the intrusion prohibited zone is a zone including a facility that would be used to abscond during release on bail or on parole. Alternatively, if the target person is out on bail or on parole, the intrusion prohibited zone is a zone that is set at least in accordance with one or more attributes of the target person.

For example, the attributes include the sex and nationality of the target person, the criminal charge of the target person, a petition from a victim, a petition from the target person, etc. The criminal charge of the target person indicates the type of crime that resulted in the target person being released on bail or on parole. The petition from the victim is filed by a victim related to the target person or a person related to the victim. The petition from the target person is filed by the target person (or a lawyer representing the target person).

If the target person is a foreign national, an intrusion prohibited is set to a zone where a facility, such as an airport or a harbor, that may be used by the target person to abscond is present because the target person may abscond abroad.

For example, if the criminal charge of the target person is stalking, domestic violence, or the like, an intrusion prohibited zone is set to a zone that is considered as being related to a victim related to the target person and/or a person related to the victim in order to restrict the movement of the target person. For example, an intrusion prohibited zone is set to a zone including a facility such as a victim's residence, workplace, or commuting route, or the victim's parent's residence.

Furthermore, if a petition is filed by a victim of a crime such as stalking or domestic violence, for example, a zone designated in the petition is added to one or more intrusion prohibited zones that have been set based on the criminal charge of the target person, resulting in a new intrusion prohibited zone being set. For example, if the shelter of a victim is changed from the victim's residence to a friend's residence, or in other words, when there is a change in the victim's situation, an intrusion prohibited zone can be added by designating the friend's residence in a petition. Furthermore, if a victim moves, an intrusion prohibited zone can be changed by designating the new residence in a petition.

Furthermore, even if the target person is out on bail or on parole, in a case in which the target person is in a situation in which the target person needs to use public transport such as an airplane, the restriction of movement of the target person is lifted during a limited period if a petition is filed by the target person (or a lawyer representing the target person) and the petition is judged as being filed for a reasonable reason (if the petition is approved).

For example, in a case in which a Tokyo-based target person who is out on bail or on parole would like to use an airport in Tokyo to visit his/her parent's house in Okinawa, the target person includes this reason in a petition. Then, if the content of the petition is approved as being reasonable, entry to an airport set as an intrusion prohibited zone or a buffer zone set in the vicinity of the airport is permitted, and the restriction of the movement of the target person is lifted for a limited period.

Furthermore, if the position of the target person is included in a buffer zone that has been set in the vicinity of an intrusion prohibited zone, the determination unit 15 generates buffer-zone information including first position information and buffer information indicating that the target person has intruded the buffer zone,

The buffer-zone information includes position information indicating the current position of the target person, and buffer information (for example, a flag or the like) indicating whether or not the target person has intruded into a buffer zone. A buffer zone is a zone that is set for early detection of the intrusion of the target person into an intrusion prohibited zone. For example, a buffer zone is a zone that is optionally set to an area of a concentric circle drawn from an intrusion prohibited zone with a predetermined radius, or to a path for approaching an intrusion prohibited zone and the vicinity thereof.

For example, if an airport parking lot, a road to an airport, a station right before an airport, or the like, is the target zone, a buffer zone is set so as to surround the target zone. Furthermore, for example, if there is a direct road to a harbor, a buffer zone is set to the direct road.

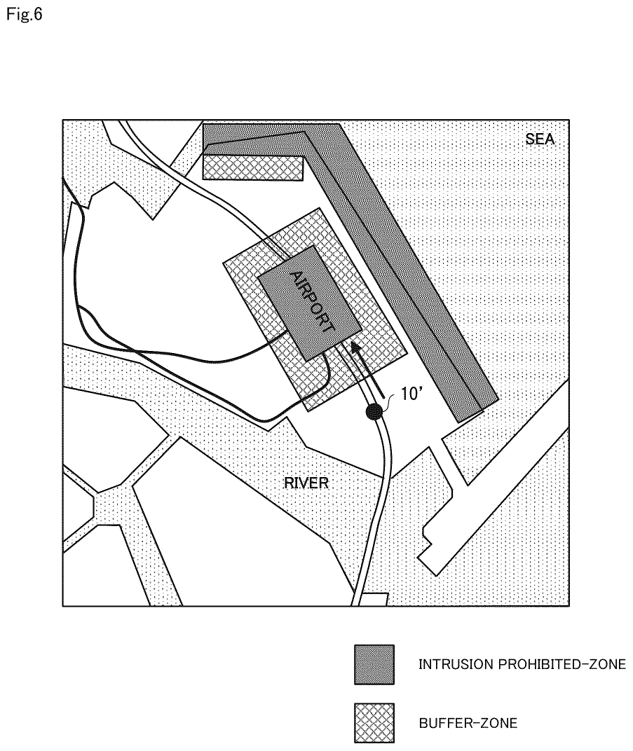

FIG. 6 is a diagram for describing intrusion prohibited zones and buffer zones. FIG. 6 illustrates a map displayed on a screen of the monitoring apparatus 30. In the example in FIG. 6, intrusion prohibited zones and buffer zones that have been set in advance are displayed on the map. When a target person (position apparatus 10; indicated by ●) approaches an airport in the direction of the arrow as illustrated in FIG. 6, the target person first intrudes into a buffer zone set in the vicinity of the airport, and thus the positioning apparatus 10 transmits buffer-zone information. Next, when the target person intrudes into an intrusion prohibited zone set to the airport, the positioning apparatus 10 transmits intrusion prohibited-zone information.

Next, the determination unit 15 outputs the intrusion prohibited-zone information or buffer-zone information that has been generated to the communication unit 16.

For example, the communication unit 16 wirelessly communicates with the relay apparatus 20. The communication unit 16 receives positioning requests from the relay apparatus 20. Furthermore, the communication unit 16 transmits, to the relay apparatus 20, positioning results on which the degradation processing has been performed. Furthermore, the communication unit 16 transmits the later-described intrusion prohibited-zone information or buffer-zone information to the relay apparatus 20.

The notification unit 17 notifies the target person that the target person has intruded into an intrusion prohibited zone or a buffer zone. If there is a screen on the positioning apparatus 10, the notification is provided by generating information for displaying an indication that the target person has intruded into an intrusion prohibited zone or a buffer zone, and displaying the indication that the target person has intruded into an intrusion prohibited zone or a buffer zone based on the generated information.

Furthermore, the positioning apparatus 10 may be vibrated as another notification method. Furthermore, notification may be provided by light by providing the positioning apparatus 10 with an LED or the like. Furthermore, notification may be provided by sound by providing the positioning apparatus 10 with a speaker.

The relay apparatus will be described.

For example, the relay apparatus 20 is an apparatus owned by a business operator providing a service in which the Global Positioning System (GPS), a global navigation satellite system (GNSS), etc., is used, or the like. The relay apparatus 20 receives a positioning request that is an instruction to start positioning and transmitted from the monitoring apparatus 30 via a communication network. Then, the relay apparatus 20 transmits the received positioning request to the positioning apparatus 10.

Furthermore, the relay apparatus 20 receives a positioning result that is a result of positioning by the positioning apparatus 10 and transmitted from the positioning apparatus 10. Then, the relay apparatus 20 transmits the received positioning result to the monitoring apparatus 30 via the communication network.

Furthermore, the relay apparatus 20 receives intrusion prohibited-zone information or buffer-zone information that is generated by the positioning apparatus 10 and transmitted from the positioning apparatus 10. Then, the relay apparatus 20 transmits the received intrusion prohibited-zone information and/or buffer-zone information to the positioning apparatus 10.

The monitoring apparatus will be described.

For example, the monitoring apparatus 30 is an information processing terminal such as a server computer, a personal computer, or a mobile terminal. The monitoring apparatus 30 transmits positioning requests to the relay apparatus 20 via a communication network. The monitoring apparatus 30 receives, via the communication network, positioning results transmitted from the relay apparatus 20. Furthermore, the monitoring apparatus 30 receives, via the communication network, intrusion prohibited-zone information or buffer-zone information transmitted from the relay apparatus 20.

The monitoring apparatus 30 includes a privacy-violation-zone-setting-information generation unit 31, an intrusion prohibited-zone-setting-information generation unit 32, a buffer-zone-setting-information generation unit 33, a communication unit 34, an output-information generation unit 35, and a storage unit 36. Furthermore, the monitoring apparatus 30 is connected to an output apparatus 40.

The output apparatus 40 acquires output information converted into an outputtable format by the output-information generation unit 35, and outputs images and sound generated based on the output information. For example, the output apparatus 40 is an image display device in which liquid crystal, organic electroluminescence (EL), or a cathode ray tube (CRT) is used, or the like. Furthermore, the image display device may include a sound output device such as a speaker or the like. Note that the output apparatus 40 may be a printing device such as a printer.

The privacy-violation-zone-setting-information generation unit 31 generates privacy-violation-zone setting information for setting, to the positioning apparatus 10 worn by the target person being monitored, a privacy violation zone that would result in the privacy of the target person being violated.

Specifically, the privacy-violation-zone-setting-information generation unit 31 first acquires privacy-violation-related information that would result in the privacy of the target person being violated and that is stored in the storage unit 36.

For example, the privacy-violation-related information is information relating to a zone in which the target person's residence, a medical facility (for example, a hospital or pharmacy) that the target person is visiting, or the like is present, or a zone in which, if the target person is in the position of the zone, the target person would suffer from disadvantages such as irrational discrimination or prejudice directed toward the target person him or herself such as those based on race, belief, social status, medical history, criminal record, and the fact of being victim to a crime, or the like.

Next, based on the privacy-violation-related information, the privacy-violation-zone-setting-information generation unit 31 generates privacy-violation-zone setting information for setting a privacy violation zone to the positioning apparatus 10, for each target person. Furthermore, the privacy-violation-zone-setting-information generation unit 31 transmits the privacy-violation-zone setting information to the positioning apparatus 10 via the communication unit 34.

Then, upon receiving the privacy-violation-zone setting information, the positioning apparatus 10 sets a privacy violation zone based on the received privacy-violation-zone setting information.

Based on the reason why the target person is being monitored, the intrusion prohibited-zone-setting-information generation unit 32 generates intrusion prohibited-zone setting information for setting an intrusion prohibited zone to the positioning apparatus 10. Specifically, the intrusion prohibited-zone-setting-information generation unit 32 first acquires attribute information corresponding to the target person that is stored in the storage unit 36.

For example, the attribute information includes the sex and nationality of the target person, the criminal charge of the target person, a petition from a victim, a petition from the target person, etc.

Based on the attribute information, the intrusion prohibited-zone-setting-information generation unit 32 generates intrusion prohibited-zone setting information for setting an intrusion prohibited zone to the positioning apparatus 10, for each target person.

If the target person is out on bail or on parole, an intrusion prohibited zone is a zone including a facility that would be used to abscond during release on bail or on parole. Alternatively, if the target person is out on bail or on parole, an intrusion prohibited zone is a zone that is set at least in accordance with one or more attributes of the target person.

Furthermore, the intrusion prohibited-zone-setting-information generation unit 32 transmits the intrusion prohibited-zone setting information to the positioning apparatus 10 via the communication unit 34.

Then, upon receiving the intrusion prohibited-zone setting information, the positioning apparatus 10 sets an intrusion prohibited zone based on the intrusion prohibited-zone setting information.

The buffer-zone-setting-information generation unit 33 generates buffer-zone setting information for setting a buffer zone in the vicinity of an intrusion prohibited zone. Specifically, for example, the buffer-zone-setting-information generation unit 33 optionally sets a buffer zone to an area of a concentric circle drawn from an intrusion prohibited zone with a predetermined radius, or to a path for approaching an intrusion prohibited zone and the vicinity thereof.

Next, the buffer-zone-setting-information generation unit 33 generates buffer-zone setting information for setting the buffer zone to the positioning apparatus 10. Furthermore, the buffer-zone-setting-information generation unit 33 transmits the buffer-zone setting information for setting the buffer zone to the positioning apparatus 10 via the communication unit 34.

Then, upon receiving the buffer-zone setting information, the positioning apparatus 10 sets a buffer zone based on the buffer-zone setting information.

The communication unit 34 transmits privacy-violation-zone setting information, intrusion prohibited-zone setting information, and buffer-zone setting information to the positioning apparatus 10. Furthermore, the communication unit 34 receives at least intrusion prohibited-zone information or buffer-zone information via the relay apparatus 20 of the positioning apparatus 10.

Upon receiving intrusion prohibited-zone information, the output-information generation unit 35 generates output information indicating that the target person has intruded into an intrusion prohibited zone, and, upon receiving buffer-zone information, the output-information generation unit 35 outputs, to the output apparatus, output information indicating that the target person has intruded into a buffer zone. Then, the output-information generation unit 35 outputs the output information to the output apparatus 40.

The storage unit 36 at least stores privacy-violation-zone setting information, intrusion prohibited-zone setting information, buffer-zone setting information, positioning results, intrusion prohibited-zone information, and buffer-zone information. Furthermore, the storage unit 36 stores information set to the positioning apparatus 10.

While the storage unit 36 is provided inside the monitoring apparatus 30 in the example in FIG. 1, the storage unit 36 may be provided outside the monitoring apparatus 30. For example, a database, a server computer, a memory, or the like is conceivable as the storage unit 36.

State display information will be described.

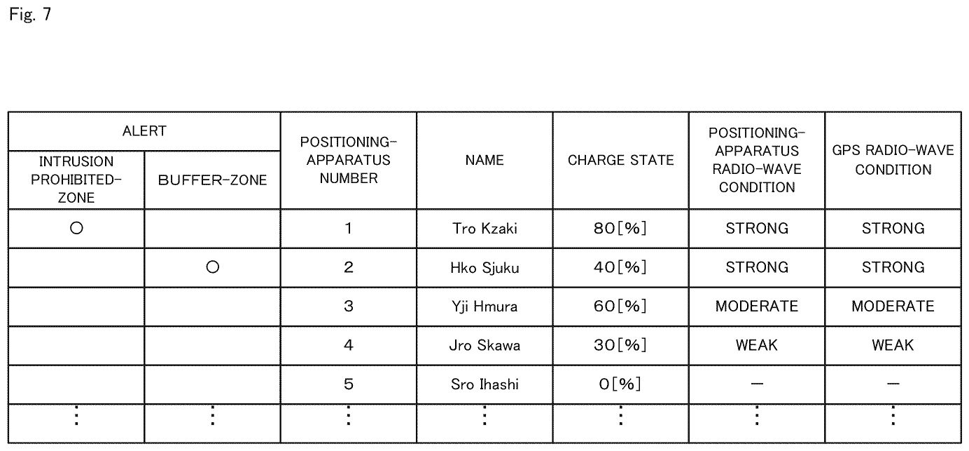

FIG. 7 is a diagram for describing an example of state display information. Upon generating state display information, the monitoring apparatus 30 first receives intrusion prohibited-zone information or buffer-zone information. Furthermore, the monitoring apparatus 30 may receive, from the positioning apparatus 10, information such as a positioning-apparatus number, a charge state, positioning-apparatus-radio-wave-condition information, and GPS/GNSS-radio-wave-condition information.

Then, the output-information generation unit 35 of the monitoring apparatus 30 generates state display information (output information) using the received information, and outputs the state display information to the output apparatus 40.

The state display information is information to be displayed by the monitoring apparatus 30 of an operator who is performing monitoring. The state display information is displayed on the screen of the output apparatus 40. As illustrated in FIG. 7, the state display information is information in which an alert, a positioning-apparatus number, a name, a charge state, a positioning-apparatus radio-wave condition, and a GPS/GNSS radio-wave condition are associated with one another.

In the alert field, information indicating that a target person has intruded into an intrusion prohibited zone or information indicating that a target person has intruded into a buffer zone is displayed. In the positioning-apparatus number field, information indicating a number allocated in advance to each positioning apparatus is displayed.

In the name field, information indicating the name of the target person is displayed. In the charge state field, information (for example, a residual-capacity level, or the like) indicating the residual capacity of a battery (unillustrated) installed in the positioning apparatus 10 is displayed. In the positioning-apparatus radio-wave condition field, information (for example, a radio-wave intensity level, or the like) indicating the intensity of radio waves transmitted from the positioning apparatus 10 is displayed. In the GPS/GNSS radio-wave condition field, information (for example, a radio-wave intensity level, or the like) indicating the intensity of radio waves transmitted from the GPS/GNSS is displayed.

In the example in FIG. 7, because “Tro Kzaki”, who is a target person wearing the positioning apparatus 10 with the positioning-apparatus number “1”, has intruded into an intrusion prohibited zone, an alert indication “◯” indicating that the target person has intruded into an intrusion prohibited zone is displayed in an intrusion prohibited zone field in the alert field. Note that the indication “◯” is deleted if the target person leaves the intrusion prohibited zone. Furthermore, the indication is not limited to “◯”, and any indication or output (for example, sound or the like) may be adopted allowing an alert to be provided that a target person has intruded an intrusion prohibited zone.

Furthermore, a target person having intruded into an intrusion prohibited zone is displayed with top priority. For example, such a target person is displayed at the top of the table in FIG. 7. Furthermore, because a target person may repeatedly intrude into an intrusion prohibited zone, the number of times a target person has intruded into an intrusion prohibited zone may be displayed.

Furthermore, in the example in FIG. 7, because “Hko Sjuku”, who is a target person wearing the positioning apparatus 10 with the positioning-apparatus number “2”, has intruded into a buffer zone, an alert indication “◯” indicating that the target person has intruded into a buffer zone is displayed in a buffer zone field in the alert field. Note that the indication “◯” is deleted if the target person leaves the buffer zone. Furthermore, the indication is not limited to “◯”, and any indication or output (for example, sound or the like) may be adopted allowing an alert to be provided that a target person has intruded into a buffer zone.

Furthermore, if there is no target person having intruded into an intrusion prohibited zone, a target person having intruded into a buffer zone is displayed with top priority. Furthermore, because a target person may repeatedly intrude into a buffer zone, the number of times a target person has intruded into a buffer zone may be displayed.

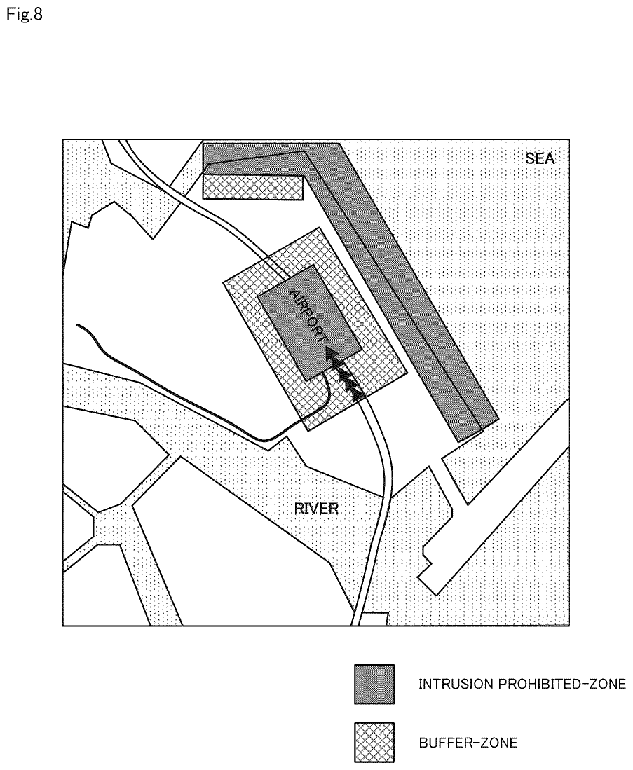

Intrusion-route display information will be described. FIG. 8 is a diagram for describing an example of intrusion-route display information. The output-information generation unit 35 generates intrusion-route display information as output information, and outputs the state display information to the output apparatus 40.

The intrusion-route display information is displayed to an operator monitoring a target person. The intrusion-route display information is displayed on the screen of the output apparatus 40. If the target person has intruded into an intrusion prohibited zone or a buffer zone, the current position of the target person is displayed in the intrusion-route display information. It is conceivable to display an indication (“▴”) of positions from intrusion to the current time point in time series on a map, as illustrated in FIG. 8. However, the indication of the positions of the target person is not limited to “▴”.

Intruder-details display information will be described.

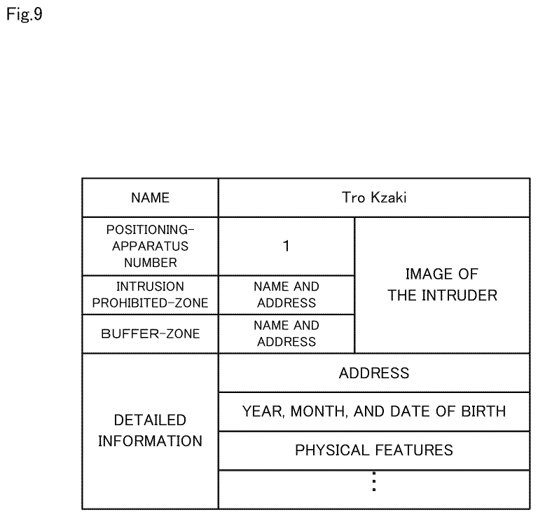

FIG. 9 is a diagram for describing an example of intruder-details display information. The output-information generation unit 35 generates intruder-details display information as output information.

FIG. 9 illustrates intruder-details display information of “Mr. T. K.”, who is the target person wearing the positioning apparatus 10 with positioning-apparatus number “1” and who has intruded into an intrusion prohibited zone.

The intruder-details display information is displayed to an operator who is monitoring the target person. The intruder-details display information is displayed on the screen of the output apparatus 40. The intruder-details display information is information in which an intruder's name, a positioning-apparatus number, a name and address of an intrusion prohibited zone; a name and address of a buffer zone, an image of the intruder, and detailed information of the intruder (address, year, month, and date of birth, physical features, etc.) are associated with one another.

### [Apparatus Operations]

Operations of the positioning apparatus will be described.

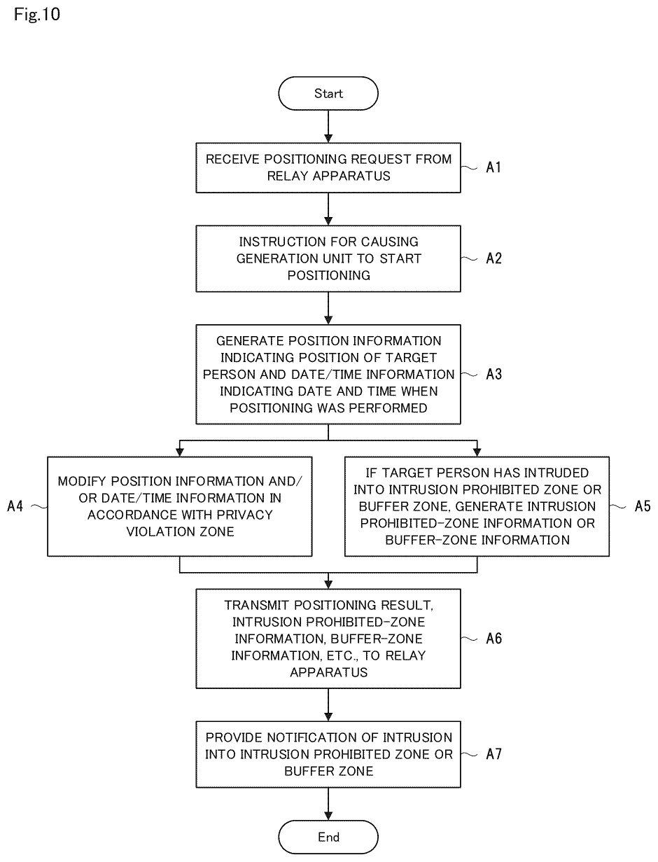

FIG. 10 is a diagram for describing an example of operations of the positioning apparatus. Drawings will be referred to as needed in the following description. Furthermore, in the example embodiment, a positioning method is implemented by causing the positioning apparatus to operate. Accordingly, the following description of the operations performed by the positioning apparatus is substituted for the description of the positioning method in the example embodiment.

The communication unit 16 receives a positioning request from the relay apparatus 20 (step A1). Next, upon receiving the positioning request from the communication unit 16, the control unit 13 outputs an instruction for causing the generation unit 12 to start positioning (step A2).

Next, by performing positioning processing using satellite signals, the generation unit 12 generates position information (first position information) indicating the position (latitude and longitude) of the target person and date/time information (first date/time information) indicating the date and time when positioning was performed (step A3).

Next, the control unit 13 acquires the positioning result generated by the generation unit 12 (first position information and/or first date/time information). Next, the control unit 13 outputs the positioning result to the modification unit 14.

Next, if the current position of the target person (positioning result) is included in a privacy violation zone including a position resulting in the privacy of the target person being violated, the modification unit 14 modifies the positioning result (first position information and/or first date/time information) (step A4). However, if the current position of the target person (positioning result) is not included in a privacy violation zone including a position resulting in the privacy of the target person being violated, the positioning result is not modified.

The modification of the positioning result is processing for making it difficult to specify that the target person was at a position resulting in the privacy of the target person being violated. The modification refers to (1) the above-described processing of deleting a positioning result in a privacy violation zone, (2) the above-described processing of disturbing a positioning result in a privacy violation zone by adding a random number to the positioning result, or (3) the above-described processing of degrading a positioning result in a privacy violation zone.

Next, if the current position of the target person (positioning result) is included in an intrusion prohibited zone or a buffer zone, the determination unit 15 generates intrusion prohibited-zone information or buffer-zone information indicating that the target person has intruded into the intrusion prohibited zone or the buffer zone (step A5).

Alternatively, in step A5, if the current position of the target person (positioning result) is not included in an intrusion prohibited zone or a buffer zone, the determination unit 15 generates intrusion prohibited-zone information or buffer-zone information indicating that the target person has not intruded into an intrusion prohibited zone or a buffer zone.

Note that it is desirable that step A4 and step A5 be executed in parallel as illustrated in FIG. 10. However, step A4 and step A5 need not be executed in parallel. Furthermore, the processing in step A4 may be omitted.

Next, the communication unit 16 acquires the positioning result on which the degradation processing has been performed from the control unit 13. Furthermore, the communication unit 16 acquires the intrusion prohibited-zone information or the buffer-zone information from the determination unit 15. Then, the communication unit 16 transmits, to the relay apparatus 20, the positioning result on which the degradation processing has been performed, and the intrusion prohibited-zone information or the buffer-zone information (step A6).

Next, the notification unit 17 notifies the target person that the target person has intruded into an intrusion prohibited zone or a buffer zone (step A7). If there is a screen on the positioning apparatus 10, the notification is provided by generating information for displaying an indication that the target person has intruded into an intrusion prohibited zone or a buffer zone, and displaying the indication that the target person has intruded into an intrusion prohibited zone or a buffer zone based on the generated information.

Furthermore, the positioning apparatus 10 may be vibrated as another notification method. Furthermore, notification may be provided by light by providing the positioning apparatus 10 with an LED or the like. Furthermore, notification may be provided by sound by providing the positioning apparatus 10 with a speaker.

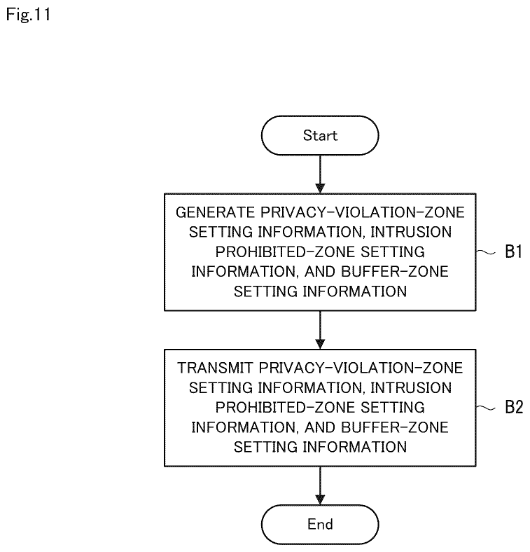

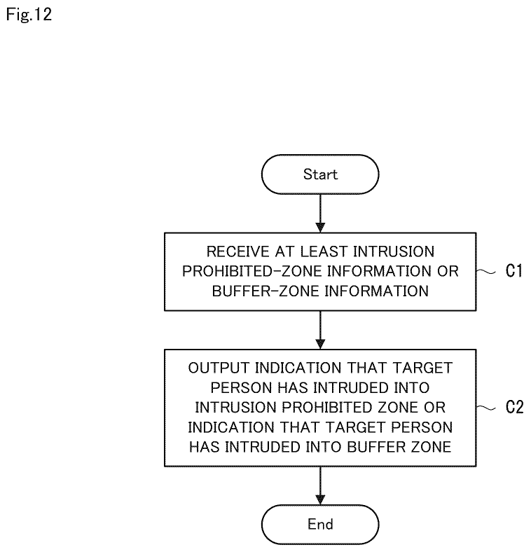

Operations of the monitoring apparatus will be described. FIGS. 11 and 12 are diagrams for describing an example of operations of the monitoring apparatus. Drawings will be referred to as needed in the following description. Furthermore, in the example embodiment, a monitoring method is implemented by causing the monitoring apparatus to operate. Accordingly, the following description of the operations performed by the monitoring apparatus is substituted for the description of the monitoring method in the example embodiment.

First, with reference to FIG. 11, the generation of privacy-violation-zone setting information, intrusion prohibited-zone setting information, and buffer-zone setting information will be described.

First, the monitoring apparatus 30 generates a privacy violation zone, intrusion prohibited-zone setting information, and buffer-zone setting information (step B1).

Specifically, in step B1, the privacy-violation-zone-setting-information generation unit 31 generates privacy-violation-zone setting information for setting, to the positioning apparatus 10 worn by the target person being monitored, a privacy violation zone that would result in the privacy of the target person being violated.

Furthermore, in step B1, based on the reason why the target person is being monitored, the intrusion prohibited-zone-setting-information generation unit 32 generates intrusion prohibited-zone setting information for setting an intrusion prohibited zone to the positioning apparatus 10.

Furthermore, in step B1, the buffer-zone-setting-information generation unit 33 generates buffer-zone setting information for setting a buffer zone in the vicinity of the intrusion prohibited zone to the positioning apparatus 10.

Next, the monitoring apparatus 30 transmits the privacy-violation-zone setting information, the intrusion prohibited-zone setting information, and the buffer-zone setting information to the positioning apparatus 10 (step B2).

Specifically, in step B2, the privacy-violation-zone-setting-information generation unit 31 transmits the privacy-violation-zone setting information to the positioning apparatus 10 via the communication unit 34.

In step B2, the intrusion prohibited-zone-setting-information generation unit 32 transmits the intrusion prohibited-zone setting information to the positioning apparatus 10 via the communication unit 34.

In step B2, the buffer-zone-setting-information generation unit 33 transmits the buffer-zone setting information for setting a buffer zone to the positioning apparatus 10 via the communication unit 34.

Then, upon receiving the privacy-violation-zone setting information, the positioning apparatus 10 sets a privacy violation zone based on the received privacy-violation-zone setting information. Alternatively, upon receiving the intrusion prohibited-zone setting information, the positioning apparatus 10 sets an intrusion prohibited zone based on the intrusion prohibited-zone setting information. Alternatively, upon receiving the buffer-zone setting information, the positioning apparatus 10 sets a buffer zone based on the buffer-zone setting information.

Next, with reference to FIG. 12, description will be provided of output for indicating to an operator that the target person has intruded into an intrusion prohibited zone or a buffer zone.

The monitoring apparatus 30 receives intrusion prohibited-zone information or buffer-zone information from the positioning apparatus 10 via the relay apparatus 20 (step C1). Next, upon receiving intrusion prohibited-zone information, the output-information generation unit 35 generates, for the output apparatus 40, output information indicating that the target person has intruded into an intrusion prohibited zone, and, upon receiving buffer-zone information, the output-information generation unit 35 outputs, to the output apparatus 40, output information indicating that the target person has intruded into a buffer zone (step C2). For example, the output information is information such as state display information, intrusion-route display information, or intruder-details display information.

### Effects of Embodiment

In the example embodiment, the privacy of a target person can be protected by degrading position information and/or date/time information by the degradation processing in a privacy violation zone.

Also, according to the example embodiment, erroneous human operations and arbitrariness can be eliminated, and, moreover, measures for ensuring appropriateness, such as certification of tamper resistance (i.e., resistance to tampering, analysis, etc., from the outside) or the like by a neutral third party, etc., can also be taken.

Also, according to the example embodiment, even if there is a concern that a target person may abscond, absconding of the target person can be detected in advance and prevented because the intrusion of the target person into an intrusion prohibited zone or a buffer zone can be detected.

Also, according to the example embodiment, an intrusion prohibited zone or a buffer zone can be set in accordance with the sex and nationality of the target person, the criminal charge of the target person, a petition from a victim, and/or a petition from the target person.

Furthermore, because it can be detected that a target person has intruded into an intrusion prohibited zone or a buffer zone, a notification can be provided to the target person. Thus, movement restriction of the target person can be performed.

Furthermore, if a target person intrudes into an intrusion prohibited zone or a buffer zone, the monitoring apparatus 30 can provide a notification to a victim or a person related to the victim to urge evacuation, whereby further harm and damage can be prevented.

### [Program]

The program of the positioning apparatus 10 in the example embodiment may be a program that causes a computer to execute steps A1 to A7 shown in FIG. 10. By installing this program in a computer and executing the program, the positioning apparatus and the positioning method according to the example embodiment can be realized. In this case, the processor of the computer performs processing to function as the antenna unit 11, the generation unit 12, the control unit 13, the modification unit 14, the determination unit 15, the communication unit 16, and the notification unit 17.

Also, the program of the positioning apparatus 10 in the example embodiment may be executed by a computer system constructed by a plurality of computers. In this case, for example, each computer may function as any of the antenna unit 11, the generation unit 12, the control unit 13, the modification unit 14, the determination unit 15, the communication unit 16, and the notification unit 17.

The program of the monitoring apparatus 30 in the example embodiment may be a program that causes a computer to execute steps B1 to B2 and C1 to C2 shown in FIG. 11. By installing this program in a computer and executing the program, the monitoring apparatus and the monitoring method according to the example embodiment can be realized. In this case, the processor of the computer performs processing to function as the privacy-violation-zone-setting-information generation unit 31, the intrusion prohibited-zone-setting-information generation unit 32, the buffer-zone-setting-information generation unit 33, and the output-information generation unit 35.

Also, the program of the positioning apparatus 10 in the example embodiment may be executed by a computer system constructed by a plurality of computers. In this case, for example, each computer may function as any of the privacy-violation-zone-setting-information generation unit 31, the intrusion prohibited-zone-setting-information generation unit 32, the buffer-zone-setting-information generation unit 33, and the output-information generation unit 35.

### [Physical Configuration]

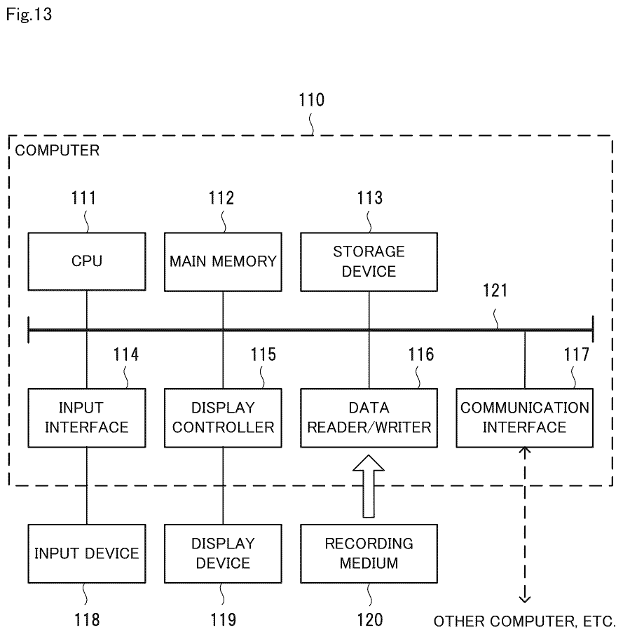

Here, a computer that realizes the positioning apparatus and monitoring apparatus by executing the program according to an example embodiment will be described with reference to FIG. 13. FIG. 13 is a diagram for describing an example of a computer that realizes the positioning apparatus and the monitoring apparatus in the example embodiment.

As shown in FIG. 13, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the positioning apparatus 10 according to this example embodiment can also be realized by using hardware corresponding to each unit. Furthermore, a portion of the positioning apparatus 10 may be realized by a program, and the remaining portion realized by hardware.

### [Supplementary Note]

Furthermore, the following supplementary notes are disclosed regarding the example embodiments described above. Some portion or all of the example embodiments described above can be realized according to (supplementary note 1) to (supplementary note 25) described below, but the below description does not limit the present invention.

### (Supplementary Note 1)

A monitoring system, wherein
a positioning apparatus:
   if the position of a target person being monitored is included in an intrusion prohibited zone that has been set based on the reason why the target person is being monitored, generates intrusion prohibited-zone information including position information indicating the position of the target person and intrusion prohibited information indicating that the target person has intruded into the intrusion prohibited zone;
   if the position of the target person is included in a buffer zone that has been set in the vicinity of the intrusion prohibited zone, generates buffer-zone information including the position information and buffer information indicating that the target person has intruded into the buffer zone; and
   transmits the intrusion prohibited-zone information to a monitoring apparatus if the position of the target person is included in the intrusion prohibited zone, and transmits the buffer-zone information to the monitoring apparatus if the position of the target person is included in the buffer zone, and
the monitoring apparatus
   upon receiving the intrusion prohibited-zone information, generates, for an output apparatus, output information indicating that the target person has intruded into the intrusion prohibited zone, and, upon receiving the buffer-zone information, generates, for the output apparatus, output information indicating that the target person has intruded into the buffer zone.

### (Supplementary Note 2)

A positioning apparatus comprising:
determination unit that determines whether or not the position of a target person being monitored is included in an intrusion prohibited zone that has been set based on the reason why the target person is being monitored; if the position of the target person is included in the intrusion prohibited zone, generates intrusion prohibited-zone information including position information indicating the position of the target person and intrusion prohibited information indicating that the target person has intruded into the intrusion prohibited zone; and, if the position of the target person is included in a buffer zone that has been set in the vicinity of the intrusion prohibited zone, generates buffer-zone information including the position information and buffer information indicating that the target person has intruded into the buffer zone; and
notification unit that notifies the target person that the target person has intruded into the intrusion prohibited zone or the buffer zone.

### (Supplementary Note 3)

The positioning apparatus according to Supplementary note 2,
wherein, if the target person is out on bail or on parole, the intrusion prohibited zone is set to a zone including a facility that would be used to abscond during release on bail or on parole.

### (Supplementary Note 4)

The positioning apparatus according to Supplementary note 3,
wherein, if the target person is out on bail or on parole, the intrusion prohibited zone is set to a zone including a facility that is considered as being related to a victim related to the target person and/or a person related to the victim.

### (Supplementary Note 5)

The positioning apparatus according to Supplementary note 3, wherein the buffer zone is set to a zone that the target person would use to intrude into the intrusion prohibited zone.

### (Supplementary Note 6)

A positioning method comprising:
a determining step of, determining whether or not the position of a target person being monitored is included in an intrusion prohibited zone that has been set based on the reason why the target person is being monitored; if the position of the target person is included in the intrusion prohibited zone, generating intrusion prohibited-zone information including position information indicating the position of the target person and intrusion prohibited information indicating that the target person has intruded into the intrusion prohibited zone; and, if the position of the target person is included in a buffer zone that has been set in the vicinity of the intrusion prohibited zone, generating buffer-zone information including the position information and buffer information indicating that the target person has intruded into the buffer zone; and
a notifying step of notifying the target person that the target person has intruded into the intrusion prohibited zone or the buffer zone.

### (Supplementary Note 7)

The positioning method according to Supplementary note 6,
wherein, if the target person is out on bail or on parole, the intrusion prohibited zone is set to a zone including a facility that would be used to abscond during release on bail or on parole.

### (Supplementary Note 8)

The positioning method according to Supplementary note 7,
wherein, if the target person is out on bail or on parole, the intrusion prohibited zone is set to a zone including a facility that is considered as being related to a victim related to the target person and/or a person related to the victim.

### (Supplementary Note 9)

The positioning method according to Supplementary note 7, wherein the buffer zone is set to a zone that the target person would use to intrude into the intrusion prohibited zone.

### (Supplementary Note 10)

A computer readable recording medium that includes a program recorded thereon, the program including instructions that cause a computer to:
a determining step of, determining whether or not the position of a target person being monitored is included in an intrusion prohibited zone that has been set based on the reason why the target person is being monitored; if the position of the target person is included in the intrusion prohibited zone, generating intrusion prohibited-zone information including position information indicating the position of the target person and intrusion prohibited information indicating that the target person has intruded into the intrusion prohibited zone; and, if the position of the target person is included in a buffer zone that has been set in the vicinity of the intrusion prohibited zone, generating buffer-zone information including the position information and buffer information indicating that the target person has intruded into the buffer zone; and
a notifying step of notifying the target person that the target person has intruded into the intrusion prohibited zone or the buffer zone.

### (Supplementary Note 11)

The computer readable recording medium according to Supplementary note 10,
wherein, if the target person is out on bail or on parole, the intrusion prohibited zone is set to a zone including a facility that would be used to abscond during release on bail or on parole.

### (Supplementary Note 12)

The computer readable recording medium according to Supplementary note 11,
wherein, if the target person is out on bail or on parole, the intrusion prohibited zone is set to a zone including a facility that is considered as being related to a victim related to the target person and/or a person related to the victim.

### (Supplementary Note 13)

The computer readable recording medium according to Supplementary note 11,
wherein the buffer zone is set to a zone that the target person would use to intrude into the intrusion prohibited zone.

### (Supplementary Note 14)

A monitoring apparatus comprising:
an intrusion prohibited-zone-setting-information generation unit that, based on the reason why a target person is being monitored, generating intrusion prohibited-zone setting information for setting an intrusion prohibited zone to a positioning apparatus;
a buffer-zone-setting-information generation unit that generating buffer-zone setting information for setting a buffer zone in the vicinity of the intrusion prohibited zone; and
a communication unit that transmitting the intrusion prohibited-zone setting information and the buffer-zone setting information to the positioning apparatus.

### (Supplementary Note 15)

The monitoring apparatus according to Supplementary note 14,
wherein, if the target person is out on bail or on parole, the intrusion prohibited zone is set to a zone including a facility that would be used to abscond during release on bail or on parole.

### (Supplementary Note 16)

The monitoring apparatus according to Supplementary note 15,
wherein, if the target person is out on bail or on parole, the intrusion prohibited zone is set to a zone including a facility that is considered as being related to a victim related to the target person and/or a person related to the victim.

### (Supplementary Note 17)

The monitoring apparatus according to any one of claims 14 to 16 further comprising:
a communication unit that receives, from the positioning apparatus, intrusion prohibited-zone information including position information indicating the position of the target person and intrusion prohibited information indicating that the target person has intruded into the intrusion prohibited zone, or buffer-zone information including position information indicating the position of the target person and buffer information indicating that the target person has intruded into the buffer zone; and
an output-information generation unit that, upon receiving the intrusion prohibited-zone information, generates, for an output apparatus, output information indicating that the target person has intruded into the intrusion prohibited zone, and, upon receiving the buffer-zone information, generates, for the output apparatus, output information indicating that the target person has intruded into the buffer zone.

### (Supplementary Note 18)

A monitoring method comprising:
an intrusion prohibited-zone-setting-information generation step of, based on the reason why a target person is being monitored, generating intrusion prohibited-zone setting information for setting an intrusion prohibited zone to a positioning apparatus;
a buffer-zone-setting-information generation step of generating buffer-zone setting information for setting a buffer zone in the vicinity of the intrusion prohibited zone; and
a transmission step of transmitting the intrusion prohibited-zone setting information and the buffer-zone setting information to the positioning apparatus.

### (Supplementary Note 19)

The monitoring method according to Supplementary note 18,
wherein, if the target person is out on bail or on parole, the intrusion prohibited zone is set to a zone including a facility that would be used to abscond during release on bail or on parole.

### (Supplementary Note 20)

The monitoring method according to Supplementary note 19,
wherein, if the target person is out on bail or on parole, the intrusion prohibited zone is set to a zone including a facility that is considered as being related to a victim related to the target person and/or a person related to the victim.

### (Supplementary Note 21)

The monitoring method according to any one of claims 18 to 20 further comprising:
a communication step of receiving, from the positioning apparatus, intrusion prohibited-zone information including position information indicating the position of the target person and intrusion prohibited information indicating that the target person has intruded into the intrusion prohibited zone, or buffer-zone information including position information indicating the position of the target person and buffer information indicating that the target person has intruded into the buffer zone; and
an output-information generation step of generating, upon receiving the intrusion prohibited-zone information, for an output apparatus, output information indicating that the target person has intruded into the intrusion prohibited zone, and, upon receiving the buffer-zone information, generates, for the output apparatus, output information indicating that the target person has intruded into the buffer zone.

### (Supplementary Note 22)

A computer readable recording medium that includes a program recorded thereon, the program including instructions that cause a computer to:
an intrusion prohibited-zone-setting-information generation step of, based on the reason why a target person is being monitored, generating intrusion prohibited-zone setting information for setting an intrusion prohibited zone to a positioning apparatus;
a buffer-zone-setting-information generation step of generating buffer-zone setting information for setting a buffer zone in the vicinity of the intrusion prohibited zone; and
a transmission step of transmitting the intrusion prohibited-zone setting information and the buffer-zone setting information to the positioning apparatus.

### (Supplementary Note 23)

The computer readable recording medium according to Supplementary note 22,
wherein, if the target person is out on bail or on parole, the intrusion prohibited zone is set to a zone including a facility that would be used to abscond during release on bail or on parole.

### (Supplementary Note 24)

The computer readable recording medium according to Supplementary note 22,
wherein, if the target person is out on bail or on parole, the intrusion prohibited zone is set to a zone including a facility that is considered as being related to a victim related to the target person and/or a person related to the victim.

### (Supplementary Note 25)

The computer readable recording medium according to any one of Supplementary notes 22 to 24 further comprising:
a communication step of receiving, from the positioning apparatus, intrusion prohibited-zone information including position information indicating the position of the target person and intrusion prohibited information indicating that the target person has intruded into the intrusion prohibited zone, or buffer-zone information including position information indicating the position of the target person and buffer information indicating that the target person has intruded into the buffer zone; and
an output-information generation step of generating, upon receiving the intrusion prohibited-zone information, for an output apparatus, output information indicating that the target person has intruded into the intrusion prohibited zone, and, upon receiving the buffer-zone information, generates, for the output apparatus, output information indicating that the target person has intruded into the buffer zone.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention of this application.

### INDUSTRIAL APPLICABILITY

As described above, the invention prevents a target person being monitored from absconding and also protects the privacy of the target person being monitored. The invention is useful in a field where GPS/GNSS positioning is required.

This application is based upon and claims the benefit of priority from Japanese application No. 2021-200004, filed on Dec. 9, 2021, the disclosure of which is incorporated herein in its entirety by reference.

### REFERENCE SIGNS LIST

10 Positioning apparatus
11 Antenna unit
12 Generation unit
13 Control unit
14 Modification unit
15 Determination unit
16 Communication unit
17 Notification unit
20 Relay apparatus
Monitoring apparatus
31 Privacy-violation-zone-setting-information generation unit
32 Intrusion prohibited-zone-setting-information generation unit
33 Buffer-zone-setting-information generation unit
34 Communication unit
35 Output-information generation unit
36 Storage unit
40 Output apparatus
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. (canceled)

2. A positioning apparatus comprising:
at least one memory storing instructions; and
at least one processor configured to execute the instructions to:
determine whether or not the position of a target person being monitored is included in an intrusion prohibited zone that has been set based on the reason why the target person is being monitored; if the position of the target person is included in the intrusion prohibited zone, generate intrusion prohibited-zone information including position information indicating the position of the target person and intrusion prohibited information indicating that the target person has intruded into the intrusion prohibited zone; and, if the position of the target person is included in a buffer zone that has been set in the vicinity of the intrusion prohibited zone, generate buffer-zone information including the position information and buffer information indicating that the target person has intruded into the buffer zone; and
notifies the target person that the target person has intruded into the intrusion prohibited zone or the buffer zone.

3. The positioning apparatus according to claim 2,
wherein, if the target person is out on bail or on parole, the intrusion prohibited zone is set to a zone including a facility that would be used to abscond during release on bail or on parole.

4. The positioning apparatus according to claim 3,
wherein, if the target person is out on bail or on parole, the intrusion prohibited zone is set to a zone including a facility that is considered as being related to a victim related to the target person and/or a person related to the victim.

5. The positioning apparatus according to claim 3, wherein the buffer zone is set to a zone that the target person would use to intrude into the intrusion prohibited zone.

6. A positioning method comprising:
determining whether or not the position of a target person being monitored is included in an intrusion prohibited zone that has been set based on the reason why the target person is being monitored; if the position of the target person is included in the intrusion prohibited zone, generating intrusion prohibited-zone information including position information indicating the position of the target person and intrusion prohibited information indicating that the target person has intruded into the intrusion prohibited zone; and, if the position of the target person is included in a buffer zone that has been set in the vicinity of the intrusion prohibited zone, generating buffer-zone information including the position information and buffer information indicating that the target person has intruded into the buffer zone; and
notifying the target person that the target person has intruded into the intrusion prohibited zone or the buffer zone.

7. A non-transitory computer readable recording medium that includes a program recorded thereon, the program including instructions that cause a computer to:
determining whether or not the position of a target person being monitored is included in an intrusion prohibited zone that has been set based on the reason why the target person is being monitored; if the position of the target person is included in the intrusion prohibited zone, generating intrusion prohibited-zone information including position information indicating the position of the target person and intrusion prohibited information indicating that the target person has intruded into the intrusion prohibited zone; and, if the position of the target person is included in a buffer zone that has been set in the vicinity of the intrusion prohibited zone, generating buffer-zone information including the position information and buffer information indicating that the target person has intruded into the buffer zone; and
notifying the target person that the target person has intruded into the intrusion prohibited zone or the buffer zone.

8-14. (canceled)
